(19) United States
(12) Patent Application Publication
(10) Pub. No.: US 2005/0207406 A1
(43) Pub. Date: Sep. 22, 2005

(54) Transmission system with congestion control at the receiver end for deciding possible retransmission requests

(75) Inventor: Jean-Marc Reme, Montigny Le Bretonneux (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/510,789

(22) PCT Filed: Apr. 3, 2003
(86) PCT No.: PCT/IB03/01346

§ 371 Date: Oct. 12, 2004

(30) Foreign Application Priority Data
Apr. 16, 2002 (FR) 02 04719

(51) Int. Cl. H04L 12/56

(52) U.S. Cl. 370/389

(57) ABSTRACT

The invention relates to the transmission of data packets across a network that may introduce errors leading to packet losses, and across which the packets have a variable transit time. The invention comprises discriminating the losses due to congestion, losses due to transmission errors and to stopping at least certain requests for retransmission of packets in case of congestion.

### FIELD OF THE INVENTION

The invention relates to a transmission system including a transmitter comprising packet transmission means, a transmission network that may introduce errors that lead to losses of packets and across which the packets have a variable transit time, and a receiver comprising packet receiving means, lost packet detection means, means for requesting retransmission of lost packets.

The invention also relates to a transmitter and a receiver intended to be used in such a transmission system.

The invention also relates to a packet receiving method intended to be used in such a receiver, and a program comprising instructions for implementing such a receiving method when it is executed by a processor.

The invention is notably applied to the transmission of audio data or video data via the Internet network to a mobile receiver.

### BACKGROUND OF THE INVENTION

The document entitled “RTP retransmission framework” written by David Leon and Viktor Varsa and published in March 2002 on the Internet site of the IETF at the Internet address “search.ietf.org/internet-drafts/draft-leon-rtp-retransmission-02.txt” discusses the retransmission of packets. In particular in paragraph 6 is explained that the retransmission of packets increases the risk of congestion of the network. When the loss of packets is due to the congestion, reacting by requesting retransmissions further increases the congestion. In this context it is proposed to no longer use the retransmission when the number of lost packets becomes too high.

The increase of the number of lost packets is used in this prior art document as an indicator of congestion.

### SUMMARY OF THE INVENTION

The invention notably has for an object to propose another way of monitoring the congestion of the network and reacting in case of congestion.

Therefore, a transmission system according to the invention comprises a transmitter which includes packet transmission means, a transmission network that may introduce errors that lead to packet losses, and across which the packets have a variable transit time, and a receiver comprising packet receiving means, lost packet detection means, means for requesting retransmission of lost packets, means for estimating said transit time and control means for deactivating said retransmission request means for at least certain lost packets when said transit time increases to such an extent that it no longer satisfies at least one predefined criterion.

A receiver according to the invention comprises packet receiving means for receiving packets transmitted via a transmission network that may introduce errors that lead to packet losses and across which the packets have a variable transit time, means for detecting lost packets, means for requesting retransmission of lost packets, means for estimating said transit time and control means for deactivating said request means for retransmission of at least certain lost packets when said transit time increases to such an extent that it no longer satisfies at least one predefined criterion.

A method according to the invention for receiving packets transmitted via a transmission network that may introduce errors that lead to packet losses and across which network the packets have a variable transit time comprises means for detecting lost packets, means for requesting retransmission of lost packets, means for estimating said transit time and control means for deactivating said request means for retransmission of at least certain lost packets when said transit time increases to such an extent that it no longer satisfies at least one predefined criterion.

The invention thus utilizes the transit time across the network as a congestion indicator. The detection of the congestion is made at the level of the receiver so that in case of congestion the receiver can decide not to make requests for retransmission at least for certain lost packets.

Advantageously, as the packets have an importance level from several possible importance levels, said control means are provided for deactivating said means for requesting retransmission as a function of important levels of the lost packets.

The reaction of the receiver is, for example, progressive. When the beginning of a congestion is detected, the receiver decides no longer to make a request for retransmission of the least significant packets. This decision is progressively extended to other packets in rising order of importance when the congestion increases.

By way of advantage when a packet is transmitted at a transmission instant and received at a receiving instant the estimation of the transit time is made by calculating a receiving interval separating the receiving instants of a subsequent packet and of a previous packet, then by calculating the difference between said receiving interval and a transmission interval separating the transmission instants of said subsequent packet and of said previous packet, said transmission interval being contained in said subsequent packet.

For this purpose a transmitter according to the invention comprises calculation means for calculating a transmission interval that separates the transmission instants of a subsequent and of a previous packet, and transmission means of the transmission interval in said subsequent packet with a view to its use by said receiver for calculating said transit time.

This calculation mode offers the advantage of producing a precise estimate.

### BRIEF DESCRIPTION OF THE DRAWINGS

These and other aspects of the invention are apparent from and will be elucidated, by way of non-limitative example, with reference to the embodiments described hereinafter.

In the drawings:

FIG. 1 is a diagrammatic representation of an example of a transmission system according to the invention,

FIG. 2 is a flow chart of a first example of a receiving method according to the invention,

FIG. 3 is a flow chart of a second example of a receiving method according to the invention.

### DESCRIPTION OF PREFERRED EMBODIMENTS OF THE INVENTION

The invention relates to a transmission system for transmitting packets between a transmitter and a receiver. The transmitter transmits data packets to the receiver. The receiver detects lost data packets and transmits to the transmitter requests for retransmission relating to at least certain lost data packets.

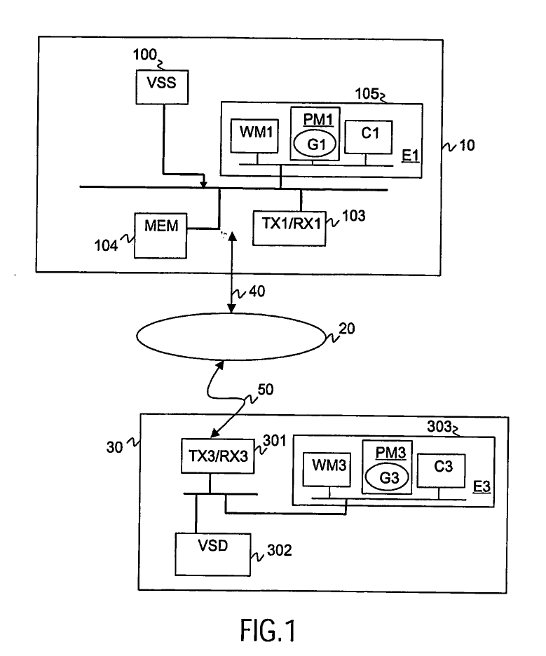

FIG. 1 shows an example of a transmission system according to the invention comprising a server 10 which performs a function of transmitter in terms of the invention, a transmission network 20 and a terminal 30 which performs the function of a receiver in terms of the invention.

The transmission network 20 is in the form of, for example, a cellular network such as a GPRS network or a UMTS network. The server 10 is connected to the transmission network 20 by means of a link 40 accessing a packet-type network like the Internet network. The terminal 30 is connected to the cellular network by means of a radio link 50.

In this type of transmission network, packet losses result either from a congestion of the packet transmission network, or transmission errors introduced by the radio link. Actually:
in case of congestion of the packet transmission network, the buffer memories of the equipment of the transmission network are full and the new packets that arrive are destroyed;
the radio links are non-reliable by nature. When they introduce too many errors in the transmitted packets, these errors cannot be corrected and the packets are considered lost.

The server 10 comprises a data source VSS represented by a block 100, a transmission/receiving device TX1/RX1 represented by a block 103, a retransmission memory MEM represented by a block 104 and a microprocessor assembly E1 represented by a block 105 and comprising a working memory WM1, a program memory PM1 and a processor C1.

The data produced by the data source VSS are put in packets at the level of the microprocessor assembly E1. The packets thus formed are transmitted to the transmission/reception device TX1/RX1 from where they are transmitted over the transmission network 20 via the link 40. In some cases the lost packets must be retransmitted when they are lost. In order to allow such a retransmission, at least part of the contents of the transmitted packets is stored in the data memory MEM.

The terminal 30 comprises a transmission/reception device TX3/RX3 represented by a block 301, a data destination unit VSD represented by a block 302 and a microprocessor assembly E3 represented by a block 303 which comprises a working memory WM3, a program memory WM3 and a processor C3.

For example, the data source VSS comprises a video sequence source and a coder in the MPEG-4 format. The data contained in the packets transmitted are data coded in the MPEG-4 format. And the data destination unit VSD comprises a decoder of the type MPEG4 and a video sequence reader.

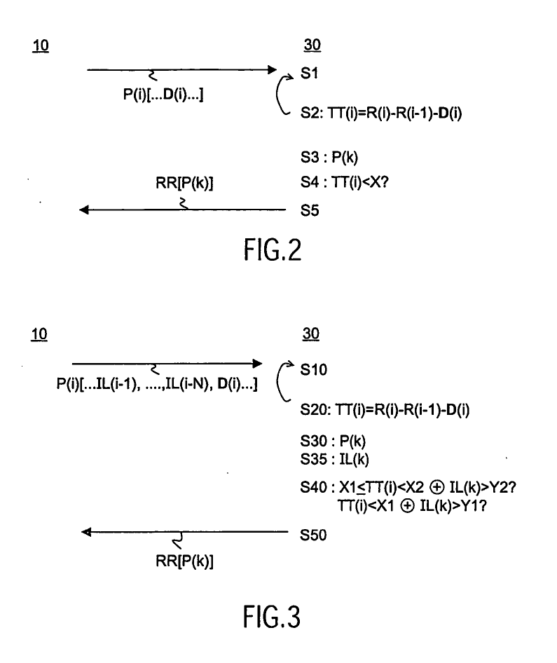

The program memories PM1 and PM3 contain a program or a set of programs G1 and G3 respectively, containing program code instructions for implementing a transmission method according to the invention as will be described with respect to FIG. 2.

Transmission between the server 10 and the terminal 30 is effected by way of advantage by utilizing a transport protocol of the type RTP. The RTP transport protocol is described in the document RFC1889 published by the IETF. In particular:
The useful data is transmitted from the server 10 to the terminal 30 in data packets of the type described in paragraph 5 of RFC1889.

These data packets contain notably a header which comprises a field called “sequence number”. The sequence number SN contained in this field is incremented by unity each time a data packet is transmitted for a given data session RTP. It is intended to be utilized by the receiver for the detection of the loss of one or more data packets in a sequence of data packets. For example, if the receiver receives a packet with the sequence number 36, followed by another packet with the sequence number 40, it deduces from this that the packets that contained the sequence numbers 37, 38 and 39 are lost. The field SN of a packet must be stored in the memory MEM in order to allow retransmission of this packet.

These data packets also contain a payload field called “payload” which contains the useful data, which is to say, in the example described here, data produced by the source VSS. The “payload” field of a packet is to be stored in the memory MEM in order to allow retransmission of this packet.

The retransmission requests are transmitted from the terminal 30 to the server 10 in control packets of the type described in paragraph 6 of RFC1889.

Original packets and retransmitted packets may either share the same RTP session or be transmitted by using two different RTP sessions.

In the following of the description it is considered that two different sessions are used for transmitting original and retransmitted packets. An RTP packet whose sequence number SN is equal to i is called P(i).

By way of advantage, to permit the estimation of transit time at the level of the receiver, a transmission interval Δ(i) is transmitted in the packets P(i). This transmission interval indicates the difference between the transmission instant t(i) of a packet P(i) and the transmission instant t(i−j) of a packet P(i−j) transmitted previously. For example, j=1 and Δ(i)=t(i)−t(i−1). The time interval Δ(i) is transmitted, for example, in a field of 32 bits in the extension of the header of the RTP packet, called RTP header extension and defined in paragraph 5.3.1 of RFC1889.

In accordance with the invention the transit time is regularly estimated based on received packets. And when a loss of packet is detected, the current value of the transit time is used for deciding to make or not to make a request for retransmission of the lost packet.

FIG. 2 shows a first example of a packet receiving method according to the invention. According to FIG. 2 such a method comprises:
a step S1 of receiving packets P(i) that contains a transmission interval Δ(i) as defined above,
a step S2 of calculating an estimate TT(i) of the transit time for the packet P(i) (in this example j is considered to be 1),
   TT(i)=R(i)−R(i−1)−Δ(i)
   where R(i) and R(i−1) are receiving instants for the packets P(i) and P(i-1),
a step S3 of detecting lost packets P(k) by observation of the sequence numbers contained in the received packets,
a step S4 of comparing the current value of the estimate TT(i) of the transit time across the network with a predefined threshold X.
   If TT(i)<X, a retransmission request RR is sent for the packet P(k) in step S5.
   If TT(i)≧X, the receiver considers a congestion is appearing in the transmission network; no request for retransmission is thus made for the packet P(k).

In another embodiment of the invention the decision to make or not to make a request for retransmission depends not only on the transit time across the transmission network, but also on the lost packet P(k), for example, of an importance level assigned to the packet P(k) from various possible importance levels.

An importance level is assigned, for example, to each packet transmitted at the level of the receiver. And the transmitted packets are constructed so that they comprise one or various fields (for example, in the extension of the header RTP already mentioned above) containing the importance level associated with one or various other packets. For example, each transmitted packet P(i) contains N importance levels IL(i−1), . . . , IL(i−N) relating to N packets that precede in the order of transmission P(i−1), . . . P(i−N).

When the data to be transmitted are data coded in the MPEG4 format, the importance level of a packet is, for example, a function of the coding mode used for coding the data transmitted in this packet. The MPEG-4 standard provides three coding modes:
the coding mode I (intracoding) in which an image is only coded based on information that it contains itself,
the coding mode P (predictive coding) in which an image is coded by utilizing a reference image that precedes in time,
the coding mode B (bidirectional predictive coding) in which an image is coded based on a reference image that precedes it in time and a reference image that follows it in time.

The images coded via the use of the coding mode I are particularly important because their loss prevents reconstructing the images for the coding of which it has served as a reference image. In an advantageous manner the server 10 thus assigns a higher importance to the coded images depending on the coding mode I than to images coded according to the coding mode P. Similarly, a larger importance is attributed to the images coded according to the coding mode P than to images coded according to the coding mode B.

In FIG. 3 is represented a flow chart of a second example of a receiving method according to the invention in which the decision to make or not to make a retransmission request takes the importance of the packets into account. According to FIG. 3 such a receiving method comprises:
a step S10 of receiving packets P(i) containing a transmission interval Δ(i) as defined above, and the N importance levels IL(i−1), . . . IL(i−N) relating to N packets preceding in the order of transmission P(i−1), . . . P(i−N),
a step S20 of estimating TT(i) the transit time for the packet P(i).
   TT(i)=R(i)−R(i−1)−Δ(i)
   where R(i) and R(i−1) are the receiving instants of the packets P(i) and P(i−1),
a step S30 of detecting lost packets P(k) by observation of the sequence numbers contained in the received packets,
a step S35 of recovering the importance level IL(k) of a lost packet P(k) in the first packet P(k+m) correctly received after the lost packet P(k),
a step S40 of deciding whether to transmit a request for retransmission RR relating to the lost packet P(k) as a function of the importance level IL(k) thus recovered, and to the current value of the transit time TT(i).
   For example
   if TT(i)≧X2, no retransmission request is made for the packet P(k)
   if X1≦TT(i)<X2 and if IL(k)>Y2, a retransmission request is sent for the packet P(k) in step S50.
   if X0<TT(i)<X1 and IL(k)>Y1 (where Y1 represents a lower importance level than Y2), a retransmission request is sent for the packet P(k) in step S50.

In this example the reaction of the receiver is progressive. When a beginning of a congestion is detected (transit time exceeding a first threshold X0, but falling short of a second threshold X1), the receiver decides no longer to make a retransmission request for the packets whose importance level is lower than Y1. This decision is extended to the packets that have an importance level lower than Y2 when the transit time becomes higher than or equal to the second threshold X1. This is finally generalized to all the packets when the transit time becomes higher than or equal to a third threshold X2. This scheme of progressiveness is described here by way of example. Other schemes of progressiveness may be used.

The invention is not restricted to the embodiments that have just been described by way of example. Modifications or improvements may be made while still remaining within the scope of the invention.

More particularly other criterions may be applied, more than those that have been described here to limit the number of retransmission requests transmitted over the network.

Other modes of estimating transit time across the network may also be used. For example, it is possible that the transmission interval Δ(i) is only transmitted for important or very important packets.

It is also possible to utilize a single session RTP for transporting the original and retransmitted packets. In that case, if the calculation mode of the transit time is used that has been described above, the retransmitted packet need not be used for calculating the transit time, because in that case the sequence number of the retransmitted packet is equal to the sequence number of the original packet). It is thus possible not to transmit the transmission interval in retransmitted packets.

The invention is not restricted to the transmission of data encoded in the MPEG-4 format. It is independent of the type of transmitted data.

In the claims the verb “to comprise” is used to mean that the use of other elements, means or steps is not excluded.

1. A transmission system including
a transmitter comprising packet transmission means,
a transmission network that may introduce errors that lead to losses of packets and across which the packets have a variable transit time,
and a receiver comprising packet receiving means, lost packet detection means, retransmission request means for requesting retransmission of lost packets, estimation means for estimating said transit time and control means for deactivating said retransmission request means for at least certain lost packets when said transit time increases to such an extent that it no longer satisfies at least one predefined criterion.

2. A system as claimed in claim 1, characterized in that said packets having an importance level from various possible importance levels, said control means are provided for deactivating said retransmission request means as a function of the importance levels of the lost packets.

3. A transmission system as claimed in claim 1, characterized in that when a packet is transmitted at a transmission instant and received at a receiving instant said transmitter comprises calculation means for calculating a transmission interval separating the transmission instants of a subsequent packet and a previous packet, said transmission interval being transmitted in said subsequent packet, and said estimation means for estimating said transit time comprise calculation means for calculating a receiving interval separating the receiving instants of said subsequent packet and said previous packet, and calculation means for calculating the difference between said receiving and transmission intervals.

4. A receiver comprising packet receiving means for receiving packets transmitted via a transmission network that may introduce errors that lead to packet losses and across which the packets have a variable transit time, means for detecting lost packets, retransmission request means for requesting retransmission of lost packets, estimator means for estimating said transit time and control means for deactivating said retransmission request means for at least certain lost packets when said transit time increases to such an extent that it no longer satisfies at least one predefined criterion.

5. A receiver as claimed in claim 4, characterized in that when a packet is transmitted at a transmission instant and received at a receiving instant, estimation means for estimating said transit time comprise calculation means for calculating a receiving interval separating the receiving instants of said subsequent packet and a previous packet, and calculation means for calculating the difference between said receiving interval and a transmission interval which separates the transmission instant of said subsequent packet and of the transmission instant said previous packet, said transmission interval being contained in said subsequent packet.

6. A receiver as claimed in claim 4, characterized in that said packets having an importance level from various possible importance levels, said control means are provided for deactivating said retransmission request means as a function of the importance level of the lost packets.

7. A method of receiving packets transmitted via a transmission network that may introduce errors that lead to packet losses and across which the packets have a variable transit time, said method comprising at least:
a lost packet detection step,
a transit time estimation step,
a step of deciding either or not to make a retransmission request for a lost packet as a function of said transit time, no retransmission request being made for at least certain lost packets when said transit time increases to such an extent that it no longer satisfies at least one predefined criterion.

8. A packet receiving method as claimed in claim 7, characterized in that when a packet is transmitted at a transmission instant and received at a receiving instant the estimation step of the transit time comprises a step of calculating a receiving interval separating the receiving instants of a subsequent packet and a previous packet, and a step of calculating the difference between said receiving interval and a transmission interval separating the transmission instants of said subsequent packet and of said previous packet, said transmission interval being contained in said subsequent packet.

9. A program comprising instructions for implementing a packet receiving method as claimed in claim 1 when said program is executed by a processor.

10. A transmitter comprising means for transmitting packets to a receiver via a transmission network across which the packets have a variable transit time, said packets being transmitted at a transmission instant and received at a receiving instant, said transmitter comprising calculation means for calculating a transmission interval separating the transmission instants of a subsequent and of a previous packet, and transmission means for transmitting said transmission interval in said subsequent packet with a view to its use by said receiver for calculating said transit time.
